(19) United States
(12) Patent Application Publication
(10) Pub. No.: US 2020/0011099 A1
(43) Pub. Date: Jan. 9, 2020

(54) Golde lockes

(71) Applicant: Mark Edd Harrelson, Van Buren, AR (US)

(72) Inventor: Mark Edd Harrelson, Van Buren, AR (US)

(21) Appl. No.: 15/998,116

(22) Filed: Jul. 5, 2018

(51) Int. Cl. E05C 19/00; E05C 1/04; E05C 1/06; E05B 63/14; E05B 17/20; E05C 19/18; E05B 55/12

(52) U.S. Cl. CPC E05C 19/003; E05C 1/04; E05C 1/06; E05B 55/12; E05B 17/2092; E05C 19/188; E05B 63/14

(57) ABSTRACT

The apparatus is a removable security flat bar that ties the entry door to the door frame support behind the wall coverings. Most dead bolts and latches only go through the door jacket not into support members. Two lag bolts are screwed into the door frame supports through the wall on the latch side, the top bolt being same height of the top of the door knob base the other bolt 1 inch down, leaving the heads of the bolts out far enough for the flat bar to slide freely. The apparatus has two notches one the size of the lag bolts the other large enough to slide over the base of a standard door knob. The apparatus come with a spacer block to be installed on the flat bar to make up the difference for the door trim. It comes with its own knob for easy removal and installing of apparatus.

### CROSS REFERENCES TO RELATED APPLICATIONS

CPC

E05C 1/04

EO5C 19/184

EO5C 19/003

E05C 1/06

E05C 1/10

EO5B 63/14

EO5B 17/2084

E05B 17/2092

E05B 1/023

E05B 55/12

E05B 63/12

EO5B 65/0082

E05B 17/2015

History of Golde Lockes,

I Mark Harrelson have worked out of town away from my wife. We lived in a house with a metal roof close to town with the back of the house to the woods. With an umbrella of trees over the house. When the wind would blow the branches would sometimes hit the roof. My wife was concerned about someone breaking into the back of the house when she was sleeping and not hear them break in. With only a light lock going into the bedroom the intruder could be in the room with little effort. My job intel's installing security doors and windows on overs seas projects and local ones. I designed this lock to put on her bedroom door. After installing this lock, she sleeps more comfortable. The lock will give someone time to call the authorities our give them time to get something to defend themselves. I have notice on most houses and apartments even the exterior doors the deadbolts only go through the door jacket which is easily kicked open. Which the change of anchoring bolts could also be used on metal doors. To make safe rooms in building.

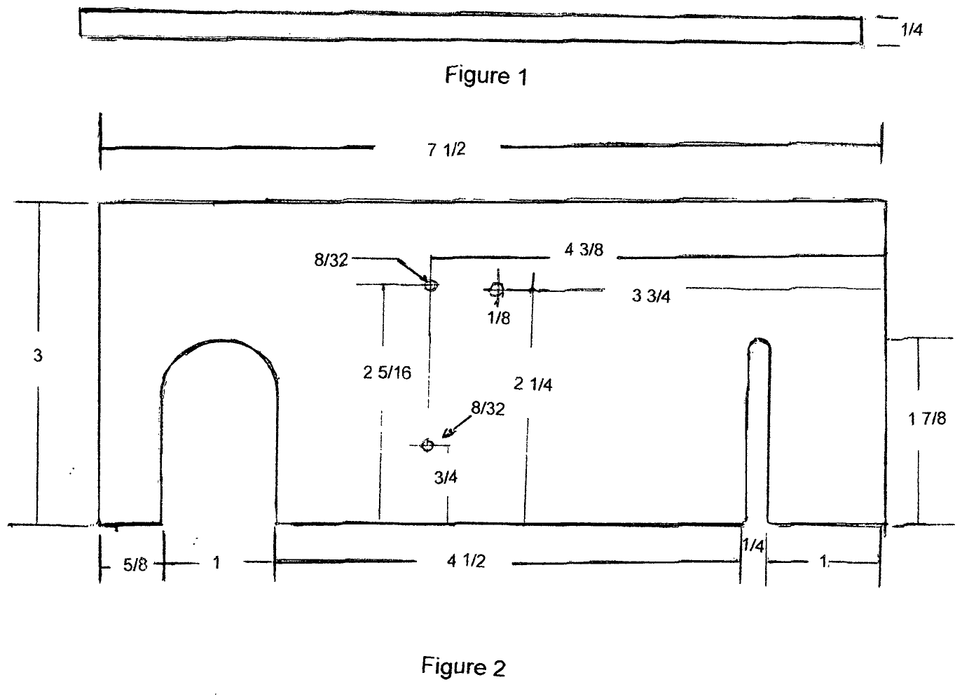

FIG. 1

Shows top of Golde Lockes ¼″ inch thick aluminum flat bar that has been painted by the means of power coated which is a baked-on finish to help prevent from chipping or wear.

FIG. 2

Shows face of Golde Lockes 7½″×3″ flat bar with the dimensions of the holes and notches for the knobs and hardware shown in the next Figures

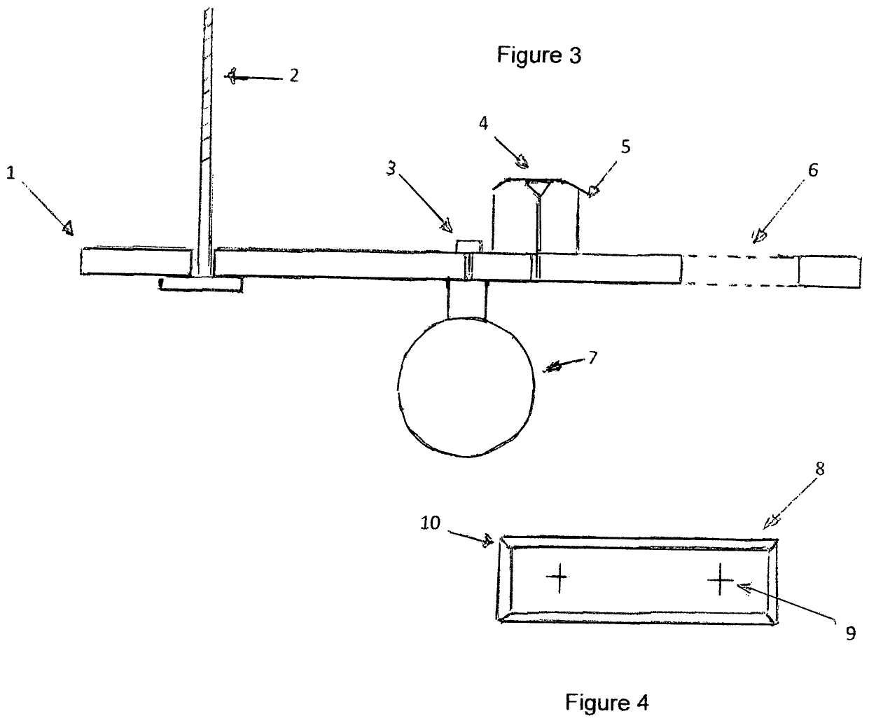

FIG. 3

Show bottom of flat bar looking up.

1. Flat bar 7½″×3″×¼″ powder coated

2. T 30 lag bolts ¼″×3″ inch 2″ provides spaced 1 inch apart anchored into 2×4 on latch side of door frame opening sliding through notch in flat bar

3. 8/32″ screw to hold knob provided placed through ⅛″ clear hole drill in bar

4. 8/32″ flat head machine screw to hold shim block in place drilled and taped in flat bar bottom of screw flush with face of flat bar.

5. Shim block used for spacer to fill void between face of trim on door and face of flat bar to prevent door from opening enough to stick something between door and jamb to remove flat bar from outside. Flat head screw is counter sunk in shim block to prevent from scratching paint on door when being removed and installed

6. Notch for the door knob to slide over for extra safety.

7. Knob used to lift and lower flat bar on lag bolts size and color varies.

FIG. 4

8. Shim block 2⅝″×¾″ predrill and countersunk for flat head screws block the purpose is to stop door from opening enough to slide something to remove the flat bar from the other side. The shim block is composed of semi-hard plastic to prevent from scratching the paint on the doors.

9. Shows location of hole to be drilled and countersunk.

10. Shim block has been beveled around perimeter for easier removal and installation.

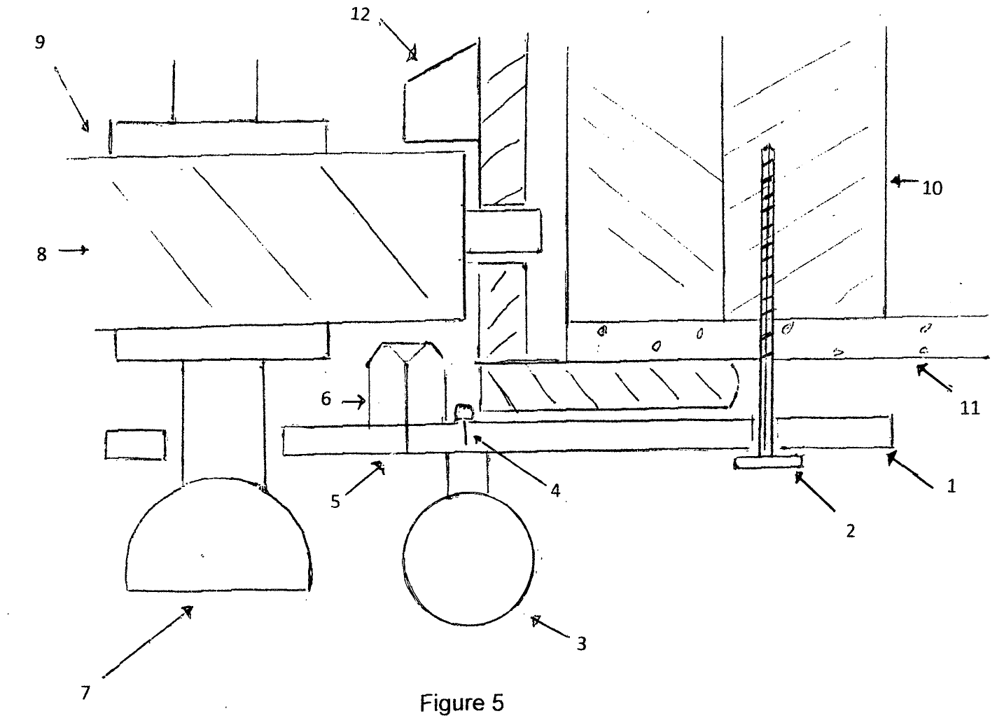

FIG. 5
1. Golde Lockes flat bar ¼″×7½″×3″ powder coated bottom view.
2. T30 lag bolts two per bar anchored into 2×4's through sheet rock at latch side of door frame.
3. Lifting Knob attached to flat bar varying in size and color per customers desire.
4. Fastener used to attach knob 8/32″×¾″ PH MS.
5. 8/32″ FH MS fastener used to anchor spacer block to flat bar.
6. Spacer block made with soft plastic fastened on with countersunk screws and beveled edges to prevent from scratching paint on doors. The block is used to prevent door from coming open enough to stick something between door and jamb to lift flat bar from intruder side.
7. Shows the knob of existing door and Golde Lockes slide over it.
8. Shows Existing door.
9. Shows outside of door.
10. Shows 2×4 door framing.
11. Shows interior sheetrock.
12. Shows door stop and door jacket.

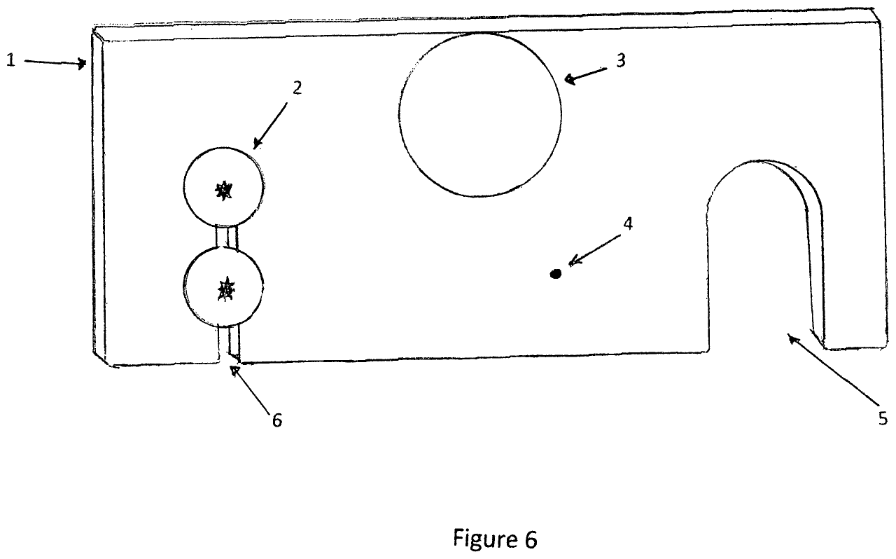

FIG. 6

1. Golde Lockes ¼″ aluminum flat bar 7½″×3″ powder coated.

2. Two T30 lag bolts ¼×3″ one inch apart.

3. Lifting and setting knob for flat bar size and color varies for customers desires.

4. Back side of bottom 8/32 bolt holding spacer block in place.

5. Slot for door knob.

6. ¼″ slot for T30 lag bolts

1. The flat bar comprising:
a flat bar predrilled with clear holes and taped holes with abalone notches
a plastic spacer block
a knob
assorted fasteners
two T30 lag bolts that anchor into the existing wall
the said T30 anchor bolts are fastened into the exiting wall supports on the latch side of the existing door, the said flat bar is designed for existing door swinging into the room that is going to be secured,
the said T30 top lag bolt is to be even with the top of the base of existing door knob the second said T30 lag bolt is to be one inch below to keep the said flat bar from dropping if existing door knob is removed
the said flat bar is the component that secures the existing door to the existing wall supports behind the wall coverings,
the said notch that is one quarter inch by one and seven eighths of an inch that is in the said flat bar slides over the said T30 lag bolts anchored into the existing wall support the said notch that is one inch by one and seven eighths of an inch in the said flat bar slides over the existing door knob,
the said plastic spacer block installed with two said fasteners on the said flat bar, it fits between the said flat bar and the existing door, it keeps the said flat bar parallel with the existing door opening trim to prevent the existing door from opening enough to get a bar through for forced entry,
the said knob is used to lift and remove the secured position and to reset the said flat bar into position when inside of room to be secured size its shape will vary per requisition,
the width, the height and thickness of the said flat bar may vary due to different sizes and makes of the existing doors also material used to make the said flat bar may change due to the purchaser's request.
